(19) United States
(12) Patent Application Publication
(10) Pub. No.: US 2026/0225612 A1
(43) Pub. Date: Aug. 6, 2026

(54) HYBRID PLANNERS FOR AUTONOMOUS VEHICLES USING LEAD-VEHICLE

(71) Applicant: Toyota Jidosha Kabushiki Kaisha, Toyota-shi (JP)

(72) Inventors: Moritz Niendorf, Palo Alto, CA (US); Ana Sofia Rufino Ferreira, Palo Alto, CA (US); Fei Sun, Palo Alto, CA (US); Aayush Ahuja, Palo Alto, CA (US); Jasper Friedrichs, Palo Alto, CA (US)

(73) Assignee: Toyota Jidosha Kabushiki Kaisha, Toyota-shi (JP)

(21) Appl. No.: 19/042,543

(22) Filed: Jan. 31, 2025

(51) Int. Cl. B60W 60/00

(52) U.S. Cl. CPC B60W 60/0011; B60W 60/00272

(57) ABSTRACT

In one embodiment, an autonomous vehicle includes one or more processors and a non-transitory computer-readable medium storing instructions that, when executed by the one or more processors, cause the one or more processors to receive local scene data, input the local scene data into a data-driven planner and an iterative trajectory optimization planner, generate, using the data-driven planner, a DDP output that includes a DDP trajectory based at least in part on the local scene data and one or more lead vehicle labels, determine a lead vehicle from the one or more lead vehicle labels, input the DDP output and the lead vehicle into the iterative trajectory optimization planner, where the DDP output and the lead vehicle are used as costs of a plurality of costs of a cost function that is minimized by the iterative trajectory optimization planner, and generate, using the iterative trajectory optimization planner, an output trajectory.

### BACKGROUND

In an autonomous vehicle software stack, the planning module (i.e., “the planner”) is responsible for determining what an autonomous vehicle should do according to the current situation. One type of a planner is a rules-based planning module that selects a trajectory by minimizing a cost function that takes into account a plurality of costs, such as keeping within a lane boundary, speed limit, comfort (i.e., jerk control), obstacle avoidance, and others. As this type of planner is rules-based, it may cause the autonomous vehicle to maneuver in a manner that is not expected by a passenger, particularly when encountering complex scenarios. In some cases, the rules-based optimization planner may select a trajectory that feels unnatural, such as taking too wide of a turn when turning right or left at an intersection.

Recently, machine learning (ML) planners have been developed. ML planners include a trained model that is trained by real-time human driving and/or simulated driving. ML planners may provide a more human-like driving experience, such as human-like lateral positioning with a lane, human-like turns and others. However, although ML planners can successfully navigate typical situations, ML planners may have difficulty in very rare scenarios. Additionally, ML planners may more frequently break rules of the road and behave in an unexpected manner. Accordingly, alternative autonomous vehicle planning modules may be desired.

### SUMMARY

In one embodiment, an autonomous vehicle includes one or more processors. The autonomous vehicle also includes a non-transitory computer-readable medium storing instructions that, when executed by the one or more processors, cause the one or more processors to receive local scene data, input the local scene data into a data-driven planner and an iterative trajectory optimization planner, generate, using the data-driven planner, a DDP output that includes a DDP trajectory based at least in part on the local scene data and includes one or more lead vehicle labels, determine a lead vehicle from the one or more lead vehicle labels, input the DDP output and the lead vehicle into the iterative trajectory optimization planner, where the DDP output and the lead vehicle are used as costs of a plurality of costs of a cost function that is minimized by the iterative trajectory optimization planner, and generate, using the iterative trajectory optimization planner, an output trajectory.

In another embodiment, a method of controlling an autonomous vehicle includes receiving local scene data, inputting the local scene data into a data-driven planner and an iterative trajectory optimization planner, generating, using the data-driven planner, a DDP output that includes a DDP trajectory based at least in part on the local scene data and includes one or more lead vehicle labels, determining a lead vehicle from the one or more lead vehicle labels, inputting the DDP output and the lead vehicle into the iterative trajectory optimization planner, where the DDP output and the lead vehicle are used as costs of a plurality of costs of a cost function that is minimized by the iterative trajectory optimization planner, generating, using the iterative trajectory optimization planner, an output trajectory, and controlling the autonomous vehicle according to the output trajectory.

In another embodiment, a computing apparatus includes one or more processors. The computing apparatus also includes a non-transitory computer-readable medium storing instructions that, when executed by the one or more processors, cause the one or more processors to receive local scene data, input the local scene data into a data-driven planner and an iterative trajectory optimization planner, generate, using the data-driven planner, a DDP output that includes a DDP trajectory based at least in part on the local scene data and includes one or more lead vehicle labels, determine a lead vehicle from the one or more lead vehicle labels, input the DDP output and the lead vehicle into the iterative trajectory optimization planner, where the DDP output and the lead vehicle are used as costs of a plurality of costs of a cost function that is minimized by the iterative trajectory optimization planner, and generate, using the iterative trajectory optimization planner, an output trajectory.

### BRIEF DESCRIPTION OF THE SEVERAL VIEWS OF THE DRAWINGS

FIG. 1 illustrates an example hybrid planner for an autonomous vehicle according to one or more embodiments described and illustrated herein.

FIG. 2 illustrates an example data-driven planner of a hybrid planner for an autonomous vehicle according to one or more embodiments described and illustrated herein.

FIG. 3 illustrates an example iterative trajectory optimization planner of a hybrid planner for an autonomous vehicle according to one or more embodiments described and illustrated herein.

FIG. 4 illustrates an example data flow of a hybrid planner for an autonomous vehicle according to one or more embodiments described and illustrated herein.

FIG. 5 illustrates a workflow for generating a lead vehicle selection for use by an iterative trajectory optimization planner according to one or more embodiments described and illustrated herein.

FIG. 6A illustrates an example ego vehicle and ado vehicle and method for lead vehicle selection according to one or more embodiments described and illustrated herein.

FIG. 6B illustrates an example ego vehicle and plurality of ado vehicles and method for lead vehicle selection according to one or more embodiments described and illustrated herein.

FIG. 7 illustrates an example data-driven planner operable to output a lead vehicle selection according to one or more embodiments described and illustrated herein.

FIG. 8 illustrates an example autonomous vehicle according to one or more embodiments described and illustrated herein.

FIG. 9 illustrates components of an autonomous vehicle according to one or more embodiments described and illustrated herein.

FIG. 10 illustrates a method for generating an output trajectory for an autonomous vehicle according to one or more embodiments described and illustrated herein.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### DETAILED DESCRIPTION

Embodiments of the present disclosure are directed to autonomous vehicles having a software stack that includes a hybrid planning module (i.e., a hybrid planner) that combines attributes of both a machine learning (ML) planning module and a rules-based planning module. A ML planning module, referred to herein as a data-driven planner (DDP), utilizes a trained model to receive sensor and map data and produce a DDP trajectory. This trajectory is then provided as an input to the rules-based planning module, referred to herein as an iterative trajectory optimization (ITO) planner, as a cost that is included among a plurality of other costs associated with a loss function. The iterative trajectory optimization planner, using the DDP trajectory, produces an output trajectory that is then converted into control signals that are used to autonomously control the autonomous vehicle.

Additionally, a lead vehicle (i.e., an ado vehicle that the autonomous ego vehicle is following behind) is also determined and used by the iterative trajectory optimization planner as a cost when developing the output trajectory. Use of the lead vehicle by the iterative trajectory optimization planner improves the quality of the output trajectory.

The combination of both planner types takes advantage of the benefits of both a ML planner and rules-based optimization planner while minimizing the effect of their deficiencies. Inclusion of the DDP trajectory as a cost in the iterative trajectory optimization planner provides for a more human-like and natural trajectory executed by the autonomous vehicle that is appreciated by the passenger(s). The ML planner is leveraged to handle more complex scenarios, whereas the rules-based optimization planner is leveraged to handle rare events for which the ML planner has not been trained. Additionally, use of the iterative trajectory optimization planner ensures that the rules of the road are followed and that obstacles are avoided.

Various embodiments of autonomous vehicles, methods of controlling autonomous vehicles, and computer apparatuses having a hybrid planning module are described in detail below.

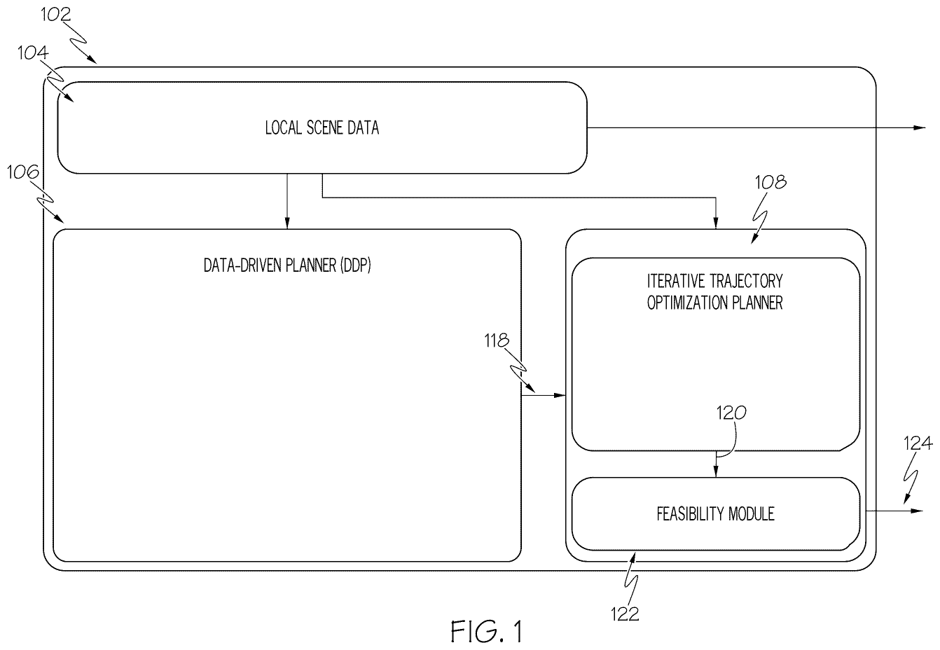

Referring now to FIG. 1, an example hybrid planner 102 of an autonomous software stack of an autonomous vehicle is schematically illustrated. It should be understood that other layers of the autonomous software stack are not shown for ease of illustration and brevity. The hybrid planner 102 generally includes a data-driven planner 106 that is machine-learning based and an iterative trajectory optimization planner 108 that is rules-based. The two planners are serially coupled such that the output of the data-driven planner 106 is provided as an input to the iterative trajectory optimization planner 108. Both the data-driven planner 106 and the iterative trajectory optimization planner 108 receive local scene data 104 that includes any type of data relating to the vehicle and the environment in which the autonomous vehicle is navigating. For example, the local scene data 104 may include vehicle sensor data, map data and external infrastructure data.

As described in more detail below, the data-driven planner 106 receives the local scene data 104 and produces a DDP output 118, which includes a DDP trajectory, using a machine-learning, data-driven approach. The DDP trajectory represents a path, speed and/or acceleration/deceleration of the vehicle that is human-like and thus typical of how a human driver would drive the autonomous vehicle.

The iterative trajectory optimization planner 108 receives the local scene data 104 and the DDP output 118 as inputs. As described in more detail below, the iterative trajectory optimization planner 108 includes a loss function that is minimized to generate an ITO trajectory 120. The loss function accounts for a plurality of costs, one or more of which are based on the DDP output 118. Thus, the iterative trajectory optimization planner 108 produces an ITO trajectory 120 that attempts to closely follow the DDP trajectory of the DDP output 118, while also taking into consideration all of the other costs of the iterative trajectory optimization planner 108.

In some embodiments, the ITO trajectory 120 outputted by the iterative trajectory optimization planner 108 is provided to a feasibility module 122, which, as described in more detail below, checks the feasibility of the ITO trajectory 120 with respect to several requirements. When the feasibility of the ITO trajectory 120 is established the feasibility module 122 outputs an output trajectory 124 that is then provided to one or more additional layers of the autonomous vehicle software stack. Ultimately, the output trajectory 124 is converted into one or more control signals that control one or more actuators of the autonomous vehicle to autonomously control the autonomous vehicle within the environment.

It is noted that FIG. 1 illustrates that the local scene data 104 may also be provided to other components of the autonomous vehicle, such as other layers of the autonomous vehicle software stack or other vehicular systems, such as an advanced driver assist system, as a non-limiting example.

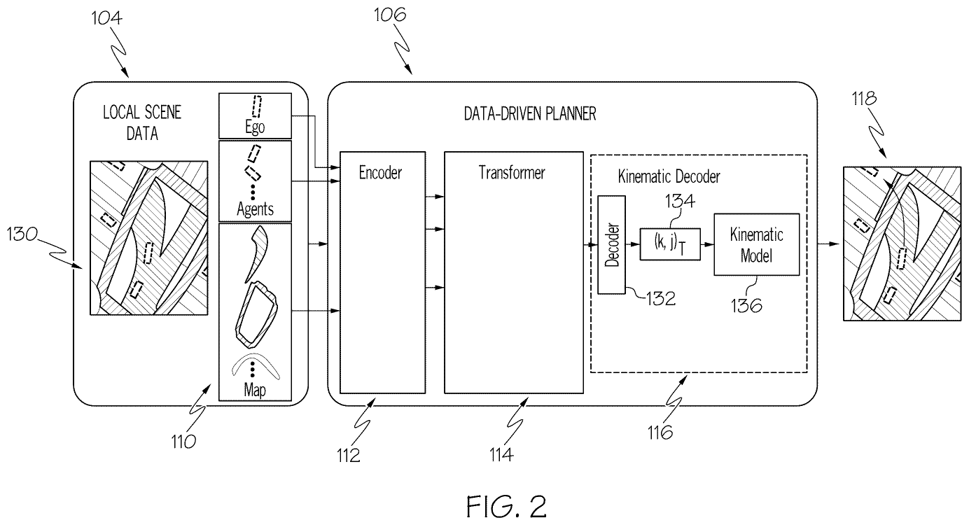

FIG. 2 illustrates the data-driven planner 106 in greater detail. It is noted that embodiments are not limited to the data-driven planner 106 of FIGS. 1 and 2, and that any machine-learning motion planner that produces a predicted trajectory may be utilized.

The local scene data 104, which may include vehicle sensor data, map data 130 (e.g., standard definition map data, enhanced standard definition map data, and/or high-definition map data), and infrastructure data (i.e., data obtained from sensors or other components external to the autonomous vehicle), is provided to the data-driven planner 106. In the example of FIG. 2, the local scene data 104 is processed into object representations 110, such as map representations, agent (e.g., other vehicles) representations, and ego (i.e., the autonomous vehicle) representations. More specifically, the object representations are vectorized polygon representations of the map data, agents and the autonomous vehicle. The vectorized object representations are referred to herein as “vectorized local scene data.” The local scene data that is converted into object representations by a vectorizer module. Each local scene object corresponds to one frame or timestep. As an example, the local scene data for consecutive frames is aggregated for consecutive frames and then passed to the vectorizer module, which converts the local scene representations to tensor/vectorized representations used an input to the data-driven planner 106.

The vectorized local scene data is provided to the data-driven planner 106 as an input to a hierarchical graph network. The first level of the hierarchical graph network is an encoder that receives the vectorized local scene data and encodes it with local information. The object representations of the vectorized local scene data may include pose information, object type, time of observation, and other information. Thus, the encoder 112 learns encoding for the scene elements provided by the local scene data 104. For example, the encoder 112 may include two separate sub-components that generate two local subgraphs: one for encoding agents/ego, and one for encoding map elements of the local scene data. The ego/agents local subgraph captures temporal information for each agent over multiple frame (i.e., it is a temporal encoding network). The local map subgraph operates over all map elements in the current frame and is not capturing temporal information. As a non-limiting example, the encoder 112 may be a PointNet-based local subgraph. It should be understood that other encoder architectures may be used to generate an embedding vector for each agent, (e.g., an ado vehicle) each map element, and the ego vehicle 138.

The second level of the hierarchical graph network is a transformer 114 generates a global embeddings by combining the local information of the encoder 112. The global embeddings of the transformer 114 are used for reasoning about interactions over agents and map features, and for translation into actions by way of a kinematic decoder 116. The transformer may include a transformer encoder architecture which uses multi-head self-attention plus feed-forward network blocks.

The global embeddings for each agent, each map element and the ego vehicle 138 may be provided to a kinematic decoder 116 that produces a DDP output 118 that includes a predicted trajectory. The kinematic decoder 116 may be used to ensure physical feasibility of the trajectory of the DDP output 118. More specifically, the kinematic decoder 116 includes a decoder 132 and a kinematic model 136. The kinematic decoder 116 receives the global embeddings from the transformer 114 and models the kinematics of the autonomous vehicle using a unicycle model. The kinematic decoder 116 may be a multilayer perceptron that predicts longitudinal jerk and curvature for each time step within a prediction horizon. The decoder 132 may be a neural network learnable module. The kinematic model 136, which may be a non-learnable model, receives these predictions as well as the current state of the autonomous vehicle to roll out the next state of the autonomous vehicle. The kinematic model 136 includes parameters for vehicle kinematic constraints, such as maximum allowed jerk, acceleration, curvature, and steering angle, which are used to clip controls to ensure physical feasibility. The result is the DDP output 118, which includes a DDP trajectory that is then provided to the iterative trajectory optimization planner 108 to be used as one or more costs.

In some embodiments, the kinematic decoder 116 is replaced by a learnable neural network decoder that is trained based on vehicle parameters and constraints. The neural network decoder may also be trained or fine-tuned using vehicle parameters to output physically feasible trajectories without the need for the kinematic decoder described above.

The data-driven planner 106 may be trained using imitation learning to train a driving policy that mimics expert driving behavior by minimizing the L1 loss between the poses generated by the model and ground truth poses. Perturbations to extend the distribution of states seen during training may be included and thus reduce the impact of the covariate shift. Large values of jerk and curvature may be penalized to reduce jerk and improve driving comfort. As a non-limiting example, the final loss is:

$$L = {\sum }_{t = 1}^{T} ‖ {p}_{t} - {\hat{p}}_{t} ‖ 1 + α ‖ {k}_{t} ‖ 2 + β ‖ {j}_{t} ‖ 2 , \qquad Eq . ( 1 )$$

Where pt is the predicted pose (xₜ, yₜ, θₜ) at time t, \hat{p}ₜ is the target pose, and α and β are hyperparameters.

It should be understood that embodiments of the present disclosure are not limited to training by imitation learning, and that other training methods may be utilized, such as reinforcement learning.

Additional information regarding the data-driven planner 106 is found at Vitelli et al., “SafetyNet: Safe planning for real-world self-driving vehicles using machine-learned policies.” As stated above, other machine-learning, data-based planner architectures may be used to produce a DDP output 118 that is used as a cost in a rules-based optimization planner, such as the iterative trajectory optimization planner 108.

In some embodiments, the data-driven planner 106 produces a plurality of DDP outputs 118 according to different parameters or preferences. For example, the data-driven planner 106 may produce different DDP outputs 118 according to various comfort levels, wherein one DDP output 118 may correspond with a DDP trajectory that corresponds to an aggressive, sport mode, and another DDP output 118 corresponds with a comfort preference. As described in more detail below, the iterative trajectory optimization planner 108 may choose which DDP output 118 to select when generating an output trajectory.

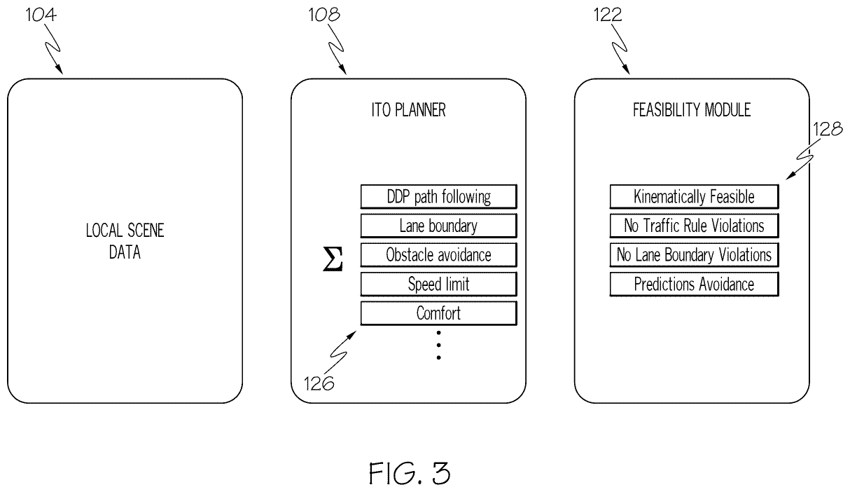

FIG. 3 illustrates the iterative trajectory optimization planner 108 and the feasibility module 122 in greater detail. The local scene data 104, which may include vehicle sensor data, map data (e.g., standard definition map data, enhanced standard definition map data, and/or high-definition map data), and infrastructure data (i.e., data obtained from sensors or other components external to the autonomous vehicle), is provided to the iterative trajectory optimization planner 108. The local scene data 104 may or not be processed in a manner that it suitable for it to be received by the iterative trajectory optimization planner 108.

The iterative trajectory optimization planner 108 solves a trajectory optimization problem in the form of a cost function. Any known or yet-to-be-developed trajectory optimization problem algorithm may be utilized. As a non-limiting example, iterative linear quadratic regulation (iLQR) may be used to solve a trajectory optimization problem that optimizes for a plurality of costs 126, one of which being the DDP output 118, and a plurality of hard and/or soft constraints (e.g., constraints on the optimization variables or any combinations of those variables). The plurality of costs 126 may include costs that are included in traditional rules-based optimization planners, such as, without limitation, lane boundary keeping, obstacle avoidance, speed limit, and comfort (i.e., jerk). The hard constraints may be, without limitation, obeying vehicle dynamics, maximum steering rate, and maximum jerk input. The soft constrains may be, without limitation, obstacle avoidance and lane boundary avoidance. The iterative trajectory optimization planner 108 outputs an ITO trajectory 120 having minimized costs associated with the cost function.

Embodiments are not limited by any particular cost function. The cost function may be engineered to have any type and number of costs. In embodiments of the present disclosure, the data-driven planner 106 provides the DDP output 118 to the iterative trajectory optimization planner 108. The DDP output 118 may provide any number of costs. For example, the DDP output may provide a DDP path cost (i.e., the path the autonomous vehicle travels), a DDP speed cost (i.e., the speed the vehicle travels), and/or DDP heading cost (i.e., the heading of the autonomous vehicle).

The ITO trajectory 120 produced by the iterative trajectory optimization planner 108 is then provided to the feasibility module 122, which checks the feasibility according to several characteristics 128, such as kinematic feasibility, legality (i.e., no traffic rule violations), no lane boundary violations, and collision likelihood. For kinematic feasibility, the feasibility module 122 evaluates whether the ITO trajectory 120 remains within a feasible envelope characterized by the dynamics limits of the autonomous vehicle. More particularly, the feasibility module 122 evaluates each trajectory state of the ITO trajectory 120 a determines whether parameters such as longitudinal jerk, longitudinal acceleration, curvature, curvature rate, lateral acceleration, and steering jerk (curvature rate x velocity) are within acceptable bounds. Lane boundary feasibility checks to determine that each stage of the ITO trajectory 120 remains within the lane boundaries of the road. The legality feasibility checks each stage of the ITO trajectory 120 to make sure no traffic rules are violated, such as running a stop sign, violation of the right of way, running a red traffic light, and leaving a drivable surface, as non-limiting examples. The collision likelihood feasibility checks each stage of the ITO trajectory 120 for the likelihood a collision with any other road agents using a prediction model that predicts poses of the other road agents. Generally collision detection may be performed by rasterizing future agent predictions and checking for overlaps with planned poses of the autonomous vehicle over the ITO trajectory.

When the feasibility module 122 indicates an ITO trajectory 120 is feasible, it is outputted as an output trajectory 124 that is ultimately used to control the autonomous vehicle. If the ITO trajectory 120 is infeasible, a fallback trajectory may be utilized, such as another candidate ITO trajectory 120.

In embodiments where the iterative trajectory planner 108 receives multiple DDP outputs 118 from the data-driven planner 106, the iterative trajectory planner 108 may select a single DDP output as one or more costs to optimize. For example, the data-driven planner 106 may output a confidence score for each DDP output 118 and the iterative trajectory planner 108 may select an individual DDP output 118 based on the confidence scores (e.g., select the DDP output 118 having the highest confidence score). As another example, the iterative trajectory planner 108 may produce multiple ITO trajectories 120 using each DDP output 118 one or more costs in individual optimizations. The feasibility module 122 may evaluate each of the ITO trajectories 120 and select the ITO trajectory 120 that is most feasible to be used as the output trajectory 124, for example.

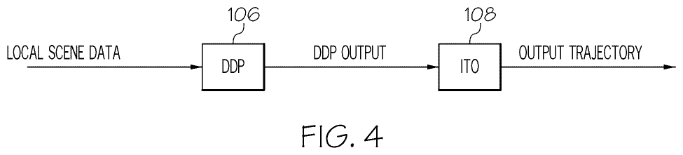

FIG. 4 is a simplified diagram of FIG. 1. As shown in FIG. 4, local scene data is provided as input to a data-driven planner 106, which produces a DDP output that includes a predicted trajectory. The predicted trajectory of the data-driven planner 106 is provided as an input to an iterative trajectory optimization planner 108. The iterative trajectory optimization planner 108 uses the DDP output 118 as one or more costs to be minimized in a rules-based optimization planner. The one or more costs associated with the DDP output 118 included with a plurality of other costs that are to be minimized by the iterative trajectory optimization planner 108, such as lane keeping, speed limit and others. The iterative trajectory optimization planner 108 produces an output trajectory that is then used to control the autonomous vehicle within an environment without human intervention.

In some embodiments, a lead vehicle determination is also used to generate the output trajectory 124 that is used to control the autonomous vehicle 138. As human drivers, we commonly follow a vehicle that is in front of us (i.e., a lead vehicle) at a certain distance to match the trajectory of the lead vehicle. In a similar manner, the iterative trajectory optimization planner 108 may use a lead vehicle in developing the output trajectory 124. The lead vehicle may be one of the costs of the cost function of the rules-based iterative trajectory optimization planner 108 that is minimized. For example, the iterative trajectory optimization planner 108 may produce a trajectory that is a close approximation of the lead vehicle, and/or the iterative trajectory optimization planner 108 may produce a trajectory that follows the lead vehicle at a certain distance.

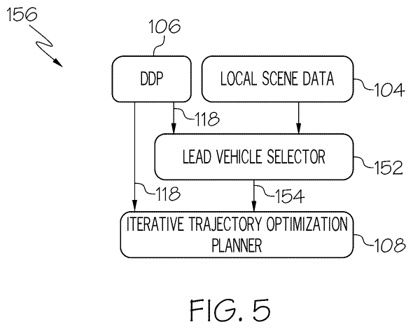

Referring now to FIG. 5, a workflow 156 of a hybrid planner incorporating both a DDP output 118 and a lead vehicle is illustrated. The data-driven planner 106 produces a DDP output 118 including a DDP trajectory that is provided to the iterative trajectory optimization planner 108, as described above and illustrated in FIG. 1. However, in the workflow 156 of FIG. 5, the DDP output 118 is also provided to a lead vehicle selector 152 that is responsible for producing a lead vehicle selection 154. The lead vehicle selection 154 is a selection of a vehicle among one or more vehicles in proximity to the autonomous vehicle 138 (i.e., ado vehicles) to be considered a lead vehicle.

The lead vehicle selector 152 receives the local scene data 104, which may include sensor data and map data as described above, and the DDP output 118. Using this information, the lead vehicle selector 152 outputs a lead vehicle selection 154 that is provided to the iterative trajectory optimization planner 108. Referring briefly again to FIG. 3, the lead vehicle selection 154 is used as a cost among the plurality of costs 126 of the cost function of the iterative trajectory optimization planner 108. One or more rules of the iterative trajectory optimization planner 108 may account for the lead vehicle selection 154 in any manner, such as staying a certain distance behind the selected lead vehicle as a non-limiting example.

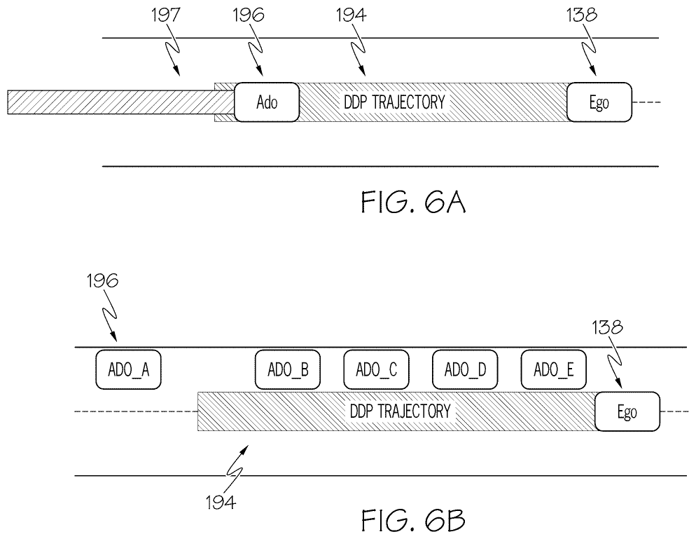

As noted above, the lead vehicle selector 152 uses both the local scene data 104 and the DDP output 118 to generate the lead vehicle selection 154. As a non-limiting example and referring to FIG. 6A, the lead vehicle selector 152 generates a polygon 194 of the DDP trajectory that is outputted by the data-driven planner 106. This polygon 194 may extend a certain distance (e.g., 5 m) to accommodate a desirable follow-behind distance, and may be continuously extended based on constant acceleration plus the certain follow-behind distance.

Additionally, obstacle polygons 196 are generated for ado vehicles within proximity of the autonomous vehicle 138. The obstacle polygons 196 are generated may be provided by the local scene data 104 as illustrated by FIG. 2 or they may be generated directly by the lead vehicle selector 152. The obstacle polygons 196 may be sorted based on their distance to the autonomous vehicle 138. The lead vehicle selector 152 then compares the various obstacle polygons 196 to the DDP trajectory polygon 194 to determine if there is an overlap. When there is an overlap, the lead vehicle selector 152 determines if a lead vehicle criteria is met. As a non-limiting example, the lead vehicle criteria may be an overlap threshold, which is a certain percentage of overlap between the obstacle polygon 196 and the DDP trajectory polygon 194 (e.g., at least 40% of the obstacle polygon 196 overlaps with the DDP trajectory polygon 194). When the lead vehicle criteria is met for a particular obstacle polygon 196, that particular obstacle polygon 196 is selected as the lead vehicle (i.e., the lead vehicle selection 154) and all other obstacle polygons 196 are set as non-lead vehicles.

In the example of FIG. 6A, the single obstacle polygon 196 is labeled as a lead vehicle because a majority of the obstacle polygon 196 overlaps the DDP trajectory obstacle polygon 196. This obstacle polygon 196 is provided to the iterative trajectory optimization planner 108 as the lead vehicle selection 154. In some embodiments, a trajectory 197 of an ado vehicle 196 is also considered when predicting an ado vehicle being a lead vehicle at some point in the future based on the trajectory 197 of the ado vehicle 196.

FIG. 6B illustrates an example where no ado vehicles are selected as a lead vehicle because none of the ado vehicles meet the lead vehicle criteria. Ado vehicles Ado_A, Ado_B, Ado_C, Ado_D and Ado_E are represented by a plurality of obstacle polygons 196. The lead vehicle selector 152 analyzes the obstacle polygons 196 by comparing them with the DDP trajectory polygon 194. As no obstacle polygons 196 overlap with the DDP trajectory polygon 194, no ado vehicle is selected as a lead vehicle. In the example of FIG. 6B, all of the ado vehicles in front of the autonomous vehicle 138 may be parked on the side of the road, and thus each are not suitable as a lead vehicle. By using the DDP trajectory in selecting a lead vehicle, accuracy of lead vehicle selection is improved because at least because selection of a parked car as a lead vehicle is prevented.

Referring once again to FIG. 5, in some embodiments the DDP output 118 includes lead vehicle labels for agents within the vicinity of the ego vehicle 138. The lead vehicle labels are predictions for each agent surrounding the ego vehicle 138 as to whether or not the particular ado vehicle is a lead vehicle or will be a lead vehicle at some point in the future (e.g., one second, two seconds, three seconds). Accordingly, the DDP output 118 includes a lead label prediction for each ado vehicle around the ego vehicle 138. The lead label predictions are provided to the lead vehicle selector 152, which applies rules to select an individual ado vehicle as the lead vehicle.

The data-driven planner 106 may be trained to label agents with respect to lead vehicle status using ground-truth data, such as human-annotated training data or auto-labeled training data.

Due to sensor capabilities and other factors, the data-driven planner 106 may only be able to make reliable predictions as lead vehicle labels for agents within a threshold distance from the ego vehicle 138. For example, the confidence level of the lead vehicle labels may be below a desired confidence level threshold when agent are further away from the ego vehicle 138 than the threshold distance. Embodiments are not limited by any threshold distance. As a non-limiting example, the threshold distance may be 70 m.

In some embodiments, the lead vehicle selector 152 employs a hybrid approach whereby it uses lead vehicle labels provided by the data-driven planner 106 for agents within the threshold distance, and uses only local scene data as described above and illustrated by FIGS. 6A and 6B for agents beyond the threshold distance, or for agents that otherwise have a low confidence level associated with the lead vehicle labels.

In some embodiments, the data-driven planner 106 selects a lead vehicle directly rather than by use of a lead vehicle selector 152, and a dedicated lead vehicle selector 152 is not used. In these embodiments, the data-driven planner 106 is trained to detect and label a vehicle as a lead vehicle, such is then provided to the iterative trajectory optimization planner 108 directly.

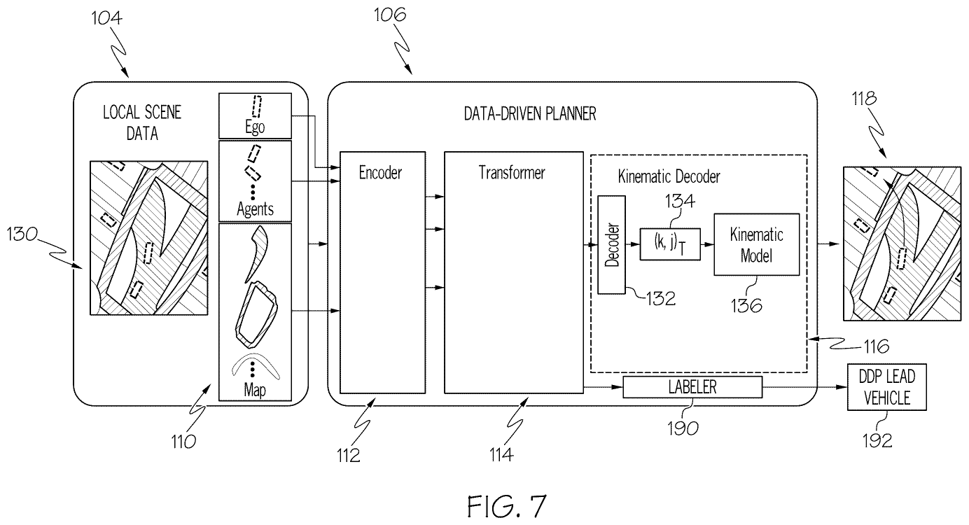

FIG. 7 illustrates an example data-driven planner 106 that is configured to output a lead vehicle selection 192 in addition to the DDP output 118 including a DDP trajectory as described above and illustrated by FIG. 2. Generally, the data-driven planner 106 includes a labeler 190 that labels a vehicle within the environment as being a lead vehicle, which is then selected as the lead vehicle selection 192.

More specifically, the ego (i.e., the autonomous vehicle 138) and agent embeddings of the global embeddings provided by the transformer 114 are used to label obstacles within the environment as provided by the local scene data. The example of FIG. 7 has an additional head compared to that of the example of FIG. 1 with the additional head that predicts obstacle labels using the labeler 190. As a non-limiting example, the labeler 190 may include one or more multi-layer perceptrons that receive the ego and agent embeddings and produce a label for a plurality of obstacles within the local scene data 104. The label may be “lead” or “not lead,” for example. The labeler 190 may apply labels for obstacles for all frames of the scene as provided by the local scene data, as well as predictions for future frames, such as one second into the future, two seconds into the future, three seconds into the future and the like.

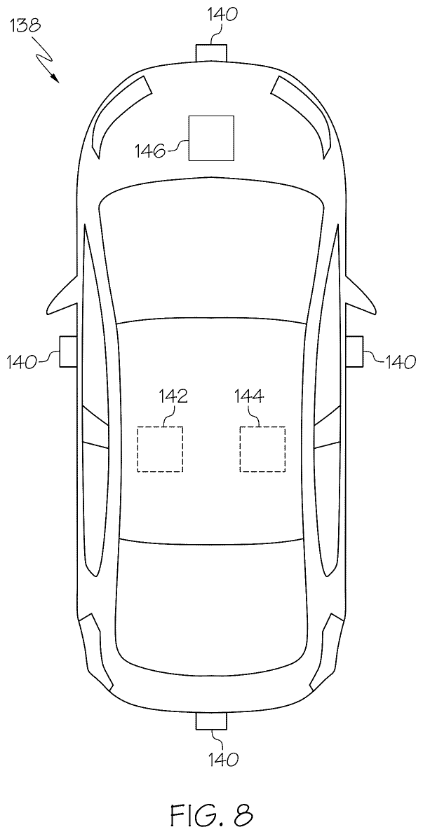

Referring now to FIG. 8, an example autonomous vehicle 138 is schematically illustrated. The autonomous vehicle 138 may be any type of autonomous vehicle. For example, the autonomous vehicle 138 may be a Level 4 or a Level 5 autonomous vehicle capable of driving without human intervention. The illustrated autonomous vehicle 138 has any number of sensors 140 that produce sensor data representing the local scene, such as cameras, lidar sensors, radar sensors, proximity sensors, speedometers, inertial measurement units (IMU), steering angle sensors, braking sensors, occupancy sensors, and any other sensor capable of detecting an attribute of the autonomous vehicle 138 and the environment in which the autonomous vehicle 138 is navigating. The example autonomous vehicle 138 also includes a global positioning system (GPS) device 142 configured to receive locational data from one or more satellites orbiting the Earth. The autonomous vehicle 138 has an autonomous driving system 144 including a software stack capable of receiving sensor data from the plurality of sensors 140, the GPS device 142 and any other data source, and generating a trajectory that is used by the autonomous vehicle 138 to drive within the environment, including the hybrid planner 102 described herein.

The autonomous vehicle 138 also includes a plurality of actuators 146 operable to receive control signals from the autonomous driving system 144 and produce motion to move the autonomous vehicle within the environment. The actuators 146 may be, without limitation, an electric motor, an engine, a steering system, a brake, an accelerator, and any other component that produces physical movement of the autonomous vehicle 138. The hybrid planner 102 produces an output trajectory 124 that is converted into control signals by the autonomous driving system 144, which are then provided to the plurality of actuators that moves the vehicle such that it completes the output trajectory 124.

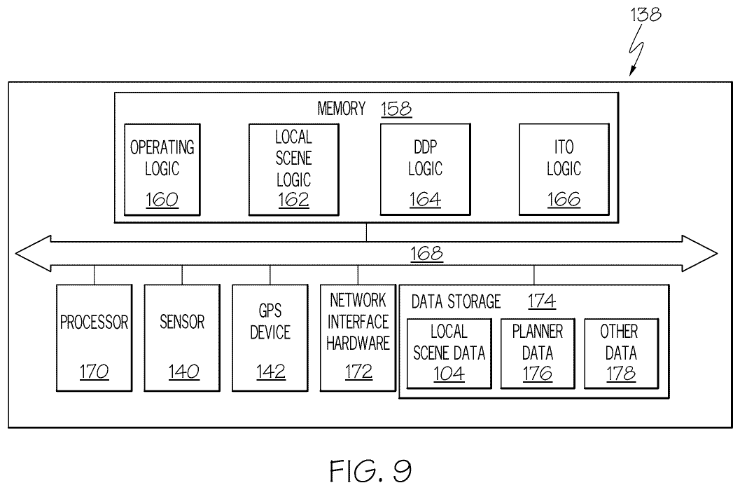

Referring now to FIG. 9, an example system of a vehicle 138 that produce an output trajectory is illustrated. The example vehicle 138 provides a system for producing an output trajectory and controlling the vehicle, and/or a non-transitory computer usable medium having computer readable program code for producing a trajectory and autonomously controlling the vehicle embodied as hardware, software, and/or firmware, according to embodiments shown and described herein. It should be understood that the software, hardware, and/or firmware components depicted in FIG. 9 may also be provided in other computing apparatuses or devices external to the vehicle 102 (e.g., data storage devices, remote server computing devices, and the like).

As also illustrated in FIG. 9, the vehicle 138 (or other computing apparatus) may include one or more processors 170, one or more sensors 140, one or more GPS devices 142, network interface hardware 172, a data storage component 174 (which may store local scene data 104, planner data 176, and any other data 178 for performing the functionalities described herein), and a non-transitory memory component 158. The non-transitory memory component 158 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 158 may be defined by transitory memory and/or signals.

Additionally, the memory component 158 may be configured to store operating logic 160 that provides a local operating system for the vehicle 138, local scene logic 162 for receiving and processing local scene data 104, DDP logic 164 for producing a DDP output that includes a predicted trajectory (and in some embodiments a lead vehicle selection), and ITO logic 166 for receiving the DDP output and a lead vehicle selection, and generating a rules-based output trajectory for controlling the autonomous vehicle (each of which may be embodied as computer readable program code, firmware, or hardware, as an example). Lead vehicle selection logic may be dedicated logic, or incorporated into the ITO logic 166 and/or the DDP logic 164. It should be understood that the data storage component 174 may reside local to and/or remote from the autonomous vehicle 138, and may be configured to store one or more pieces of data for access by the autonomous vehicle 138 and/or other components.

A local interface 168 is also included in FIG. 9 and may be implemented as a bus or other interface to facilitate communication among the components of the autonomous vehicle 138.

The one or more processors 170 may include any processing component configured to receive and execute computer readable code instructions (such as from the memory component 158 and/or the data storage component 174). The network interface hardware 172 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 158 may be the operating logic 160, local scene logic 162, DDP logic 164, and ITO logic 166. The operating logic 160 may include an operating system and/or other software for managing components of the autonomous vehicle 138 or computing apparatus. The local scene logic 162 may reside in the memory component 158 and may be configured to receive local scene data 104 (e.g., sensor data and map data) and render or otherwise process the local scene data 104 for use by the DDP logic 164 and the ITO logic 166 (e.g., vectorize the local scene data into a plurality of object representations 110). The DDP logic 164 also may reside in the memory component 158 and may be configured to produce a DDP output that includes a predicted trajectory based on the local scene data 104. The ITO logic 166 also may reside in the memory component 148 and may be configured to receive the DDP output and a lead vehicle selection and generate a rules-based output trajectory using the DDP output as costs that are minimized using a cost function. The output trajectory is used by the autonomous vehicle 138 for autonomous navigation.

It should be understood that the components illustrated in FIG. 9 are merely exemplary and are not intended to limit the scope of this disclosure. More specifically, while the components in FIG. 9 are illustrated as residing within the autonomous vehicle 138, this is a non-limiting example. In some embodiments, one or more of the components may reside external to the autonomous vehicle 138.

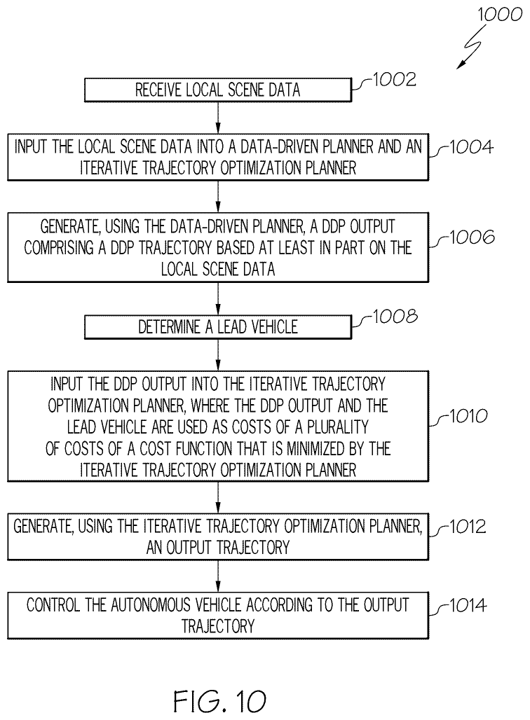

FIG. 10 illustrates a flowchart of an example method 1000 of generating a trajectory for an autonomous vehicle. In block 1002, the method 1000 includes receiving local scene data. In block 1004, local scene data is inputted into a data-driven planner and an iterative trajectory optimization planner. In block 1006, method 1000 includes generating, using the data-driven planner, a DDP output comprising a DDP trajectory based at least in part on the local scene data. In block 1008, a lead vehicle is determined. In block 1010, the method 1000 includes inputting the DDP output and the lead vehicle into the iterative trajectory optimization planner, wherein the DDP output and the lead vehicle are used as costs of a plurality of costs of a cost function that is minimized by the iterative trajectory optimization planner. In block 1012, the method 1000 includes generating, using the iterative trajectory optimization planner, an output trajectory. In block 1014, the autonomous vehicle is controlled according to the output trajectory.

It should now be understood that embodiments of the present disclosure are directed to autonomous vehicles having a software stack that includes a hybrid planner that combines attributes of both a machine learning planner and a rules-based optimization planner. The rules-based optimization planner ensures that the autonomous vehicle follows a smooth trajectory, satisfies rules of the road, and avoids obstacles. The machine learning planner (i.e., the data-driven planner) ensures a more human-like trajectory by producing a predicted trajectory that is provided to the rules-based optimization planner, which uses the predicted trajectory as a cost among a plurality of costs that are minimized to produce the output trajectory that the autonomous vehicle follows. By including the predicted trajectory as a cost, the rules-based optimization planner will attempt to select an output trajectory that closely follows the predicted trajectory, while also considering the other costs of the cost function. In this manner, the autonomous vehicle may follow a more human-like trajectory. Embodiments also select a lead vehicle that is provided to the rules-based optimization planner as an additional cost. The lead vehicle selection may be based on a predicted trajectory, or may be predicted directly by the data-driven planner. Use of the data-driven planner to select a lead vehicle prevents erroneous lead vehicle selections.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An autonomous vehicle comprising:
one or more processors;
a non-transitory computer-readable medium storing instructions that, when executed by the one or more processors, cause the one or more processors to:
receive local scene data;
input the local scene data into a data-driven planner and an iterative trajectory optimization planner;
generate, using the data-driven planner, a DDP output comprising a DDP trajectory based at least in part on the local scene data;
determine a lead vehicle;
input the DDP output and the lead vehicle into the iterative trajectory optimization planner, wherein the DDP output and the lead vehicle are used as costs of a plurality of costs of a cost function that is minimized by the iterative trajectory optimization planner; and
generate, using the iterative trajectory optimization planner, an output trajectory.

2. The autonomous vehicle of claim 1, further comprising a plurality of sensors that generate sensor data, wherein the local scene data comprises the sensor data and map data.

3. The autonomous vehicle of claim 1, wherein the data-driven planner comprises an encoder that encodes vectorized local scene data and a transformer that combines encoded local scene data from the encoder into a global embedding.

4. The autonomous vehicle of claim 1, wherein the data-driven planner labels one or more ado vehicles with a lead vehicle label, and a lead vehicle selector selects an individual ado vehicle as the lead vehicle based on the lead vehicle label of the one or more ado vehicles.

5. The autonomous vehicle of claim 1, wherein the lead vehicle is determined by:
generating a polygon of the DDP trajectory of the DDP output;
generating a polygon of an ado vehicle in front of the autonomous vehicle;
determining an overlap of the polygon of the DDP trajectory and the polygon of the ado vehicle; and
labeling the ado vehicle as the lead vehicle when the overlap exceeds an overlap threshold.

6. The autonomous vehicle of claim 1, wherein the data-driven planner labels an ado vehicle as the lead vehicle and provides the lead vehicle to the iterative trajectory optimization planner.

7. The autonomous vehicle of claim 1, further comprising one or more actuators, wherein the instructions further cause the one or more processors to:
generate one or more control signals from the output trajectory; and
provide the one or more control signals to the one or more actuators to move the autonomous vehicle within an environment.

8. A method of controlling an autonomous vehicle, the method comprising:
receiving local scene data;
inputting the local scene data into a data-driven planner and an iterative trajectory optimization planner;
generating, using the data-driven planner, a DDP output comprising a DDP trajectory based at least in part on the local scene data;
determining a lead vehicle;
inputting the DDP output and the lead vehicle into the iterative trajectory optimization planner, wherein the DDP output and the lead vehicle are used as costs of a plurality of costs of a cost function that is minimized by the iterative trajectory optimization planner;
generating, using the iterative trajectory optimization planner, an output trajectory; and
controlling the autonomous vehicle according to the output trajectory.

9. The method of claim 8, wherein the local scene data comprises map data and sensor data generated by one or more sensors of the autonomous vehicle.

10. The method of claim 8, wherein the data-driven planner comprises an encoder that encodes vectorized local scene data and a transformer that combines encoded local scene data from the encoder into a global embedding.

11. The method of claim 8, wherein the data-driven planner labels one or more ado vehicles with a lead vehicle label, and a lead vehicle selector selects an individual ado vehicle as the lead vehicle based on the lead vehicle label of the one or more ado vehicles.

12. The method of claim 8, wherein the lead vehicle is determined by:
generating a polygon of the DDP trajectory of the DDP output;
generating a polygon of an ado vehicle in front of the autonomous vehicle;
determining an overlap of the polygon of the DDP trajectory and the polygon of the ado vehicle; and
labeling the ado vehicle as the lead vehicle when the overlap exceeds an overlap threshold.

13. The method of claim 8, wherein the data-driven planner labels an ado vehicle as the lead vehicle and provides the lead vehicle to the iterative trajectory optimization planner.

14. The method of claim 8, wherein controlling the autonomous vehicle comprises generating one or more control signals from the output trajectory, and providing the one or more control signals to one or more actuators of the autonomous vehicle.

15. A computing apparatus comprising:
one or more processors; and
a non-transitory computer-readable medium storing instructions that, when executed by the one or more processors, cause the one or more processors to:
receive local scene data;
input the local scene data into a data-driven planner and an iterative trajectory optimization planner;
generate, using the data-driven planner, a DDP output comprising a DDP trajectory based at least in part on the local scene data;
determine a lead vehicle;
input the DDP output and the lead vehicle into the iterative trajectory optimization planner, wherein the DDP output and the lead vehicle are used as costs of a plurality of costs of a cost function that is minimized by the iterative trajectory optimization planner; and
generate, using the iterative trajectory optimization planner, an output trajectory.

16. The computing apparatus of claim 15, further comprising a plurality of sensors that generate sensor data, wherein the local scene data comprises the sensor data and map data.

17. The computing apparatus of claim 15, wherein the data-driven planner comprises an encoder that encodes vectorized local scene data and a transformer that combines encoded local scene data from the encoder into a global embedding.

18. The computing apparatus of claim 15, wherein the data-driven planner labels one or more ado vehicles with a lead vehicle label, and a lead vehicle selector selects an individual ado vehicle as the lead vehicle based on the lead vehicle label of the one or more ado vehicles.

19. The computing apparatus of claim 15, wherein the lead vehicle is determined by:
generating a polygon of the DDP trajectory of the DDP output;
generating a polygon of an ado vehicle;
determining an overlap of the polygon of the DDP trajectory and the polygon of the ado vehicle; and
labeling the ado vehicle as the lead vehicle when the overlap exceeds an overlap threshold.

20. The computing apparatus of claim 15, wherein the data-driven planner labels an ado vehicle as the lead vehicle and provides the lead vehicle to the iterative trajectory optimization planner.
